(19) United States
(12) Patent Application Publication
(10) Pub. No.: US 2013/0100955 A1
(43) Pub. Date: Apr. 25, 2013

(54) TECHNIQUE FOR PRIORITIZING TRAFFIC AT A ROUTER

(71) Applicant: Qualcomm Incorporated, San Diego, CA (US)

(72) Inventors: Wayne G. DUNLAP, Austin, TX (US); Benjamin M. MENCHACA, Austin, TX (US)

(73) Assignee: QUALCOMM INCORPORATED, San Diego, CA (US)

(21) Appl. No.: 13/659,579

(22) Filed: Oct. 24, 2012

Related U.S. Application Data
(60) Provisional application No. 61/550,814, filed on Oct. 24, 2011.

(51) Int. Cl. H04L 12/56

(52) U.S. Cl. 370/392; 370/389

(57) ABSTRACT

A network traffic managing node of a communication network, such as a router or gateway, can implement a network traffic routing and bandwidth management mechanism. A first application associated with a first communication stream of a communication network is determined. A first maximum bandwidth is assigned to the first communication stream. The first maximum bandwidth is determined based on a first traffic class associated with the first application. A routing of the first communication stream is managed based, at least in part, on the first traffic class and the first maximum bandwidth. A second maximum bandwidth associated with a second traffic class is assigned to the first communication stream in response to determining a bandwidth associated with the first communication stream exceeds the first maximum bandwidth. A routing of the first communication stream is managed based on the second traffic class and the second maximum bandwidth.

### RELATED APPLICATIONS

This application claims the priority benefit of U.S. Provisional Application No. 61/550,814 filed on Oct. 24, 2011.

### BACKGROUND

Embodiments of the inventive subject matter generally relate to the field of communication networks and, more particularly, to a technique for prioritizing traffic at routing devices of a communication network.

Computer devices are typically configured to communicate information over a communication network. The amount of information transmitted and received by a computer device over the communication network can be based on the available bandwidth. Various characteristics, including hardware characteristics of a computer device and the network backbone, determine the amount of bandwidth that is available to computer devices in the communication network. Furthermore, a computer device can execute multiple applications that communicate information via the communication network, which utilize some of the available bandwidth associated with the computer device. Under conventional approaches, an application can use an undesirable portion of the bandwidth, thereby impacting the performance or user experience with other applications executing at the computer device, or impacting the performance of the application itself.

### SUMMARY

Various embodiments are disclosed for implementing a network traffic routing mechanism in a communication network. In one embodiment, a first application associated with a first communication stream of a communication network is determined. The first communication stream comprises at least one packet. A first maximum bandwidth is assigned to the first communication stream. The first maximum bandwidth is determined based on a first traffic class associated with the first application. A routing of the first communication stream is managed based, at least in part, on the first traffic class and the first maximum bandwidth. A second maximum bandwidth associated with a second traffic class is assigned to the first communication stream in response to determining a bandwidth associated with the first communication stream exceeds the first maximum bandwidth associated with the first traffic class. A routing of the first communication stream is managed based on the second traffic class and the second maximum bandwidth.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram of a router that implements the network traffic prioritization and bandwidth management mechanism, according to some embodiments;

FIG. 2 illustrates a communication system incorporating the router of FIG. 1, according to some embodiments;

FIG. 3 illustrates another communication system incorporating the router of FIG. 1, according to some embodiments;

FIG. 4 illustrates a graphical user interface (GUI), according to some embodiments;

FIG. 5 is a flow diagram illustrating operations for managing routing of packets at the router based on a traffic class associated with an application type, according to some embodiments;

FIG. 6 is a flow diagram illustrating additional operations for managing routing of packets at the router based on a traffic class associated with an application type, according to some embodiments; and

FIG. 7 is a block diagram of one embodiment of a network device including the mechanism for managing routing of packets based on the traffic class associated with an application type, according to some embodiments.

### DESCRIPTION OF EMBODIMENT(S)

The description that follows includes exemplary systems, methods, techniques, instruction sequences and/or computer program products that embody techniques of the present inventive subject matter. However, it is understood that the described embodiments may be practiced without these specific details. For instance, although some examples describe a router (or other type of network traffic management node) of a communication network managing and updating a routing policy for the communication network, in other implementations the routing policy may be managed and updated remotely (e.g., in a remote computer device or server of the communication network). In other instances, well-known instruction instances, protocols, structures and techniques have not been shown in detail in order not to obfuscate the description.

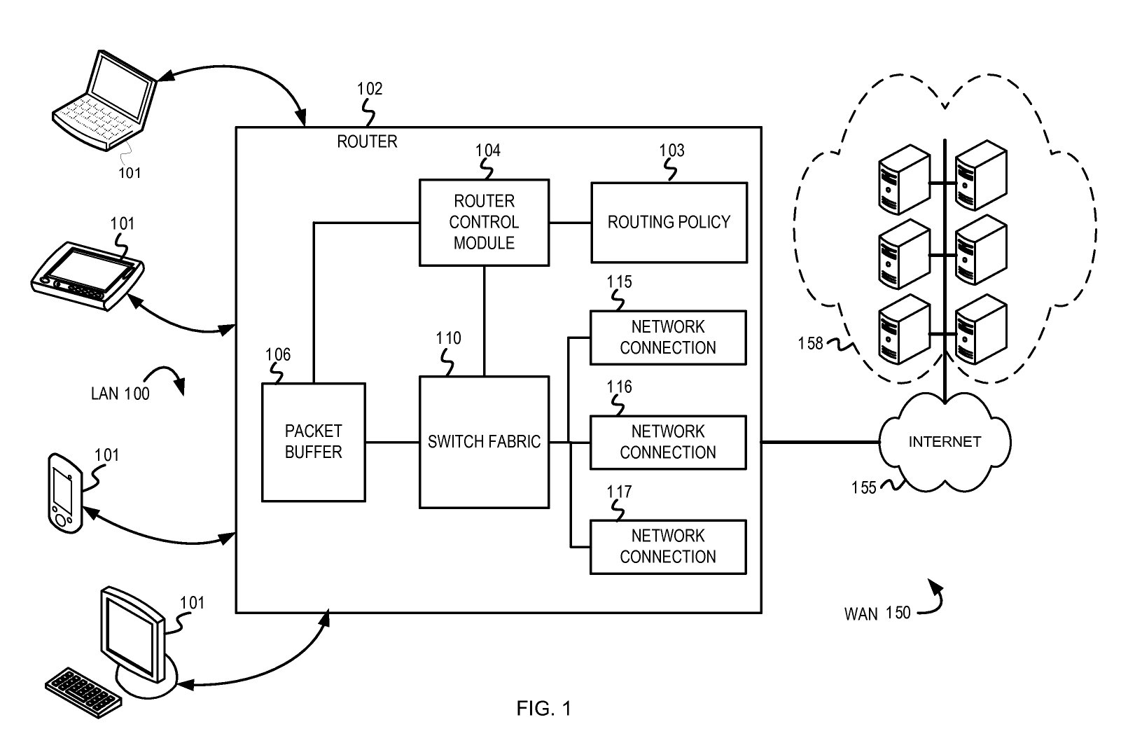

FIGS. 1-7 illustrate techniques for improving communication efficiency of a network by employing a router (or gateway) that can classify and prioritize packet communication based on the application associated with each packet, according to various embodiments. To illustrate, sets of packets associated with a common application and common purpose or function are referred to as a communication stream or packet stream (or just “stream”). In some implementations, the router can be configured to route packets of communication streams between network nodes, and to manage communication of the streams according to the application type associated with each stream. For example, the router can determine the type of application associated with a stream and then assign a minimum and a maximum amount of bandwidth to each communication stream based on the application type. Further, the router can determine the relative priority associated with each communication stream and ensure that streams do not exceed their maximum assigned bandwidth. Also, the router can ensure that higher priority streams take precedence over lower priority streams such that the higher priority streams do not fall below their assigned minimum bandwidth.

In some implementations, each stream can be assigned to one of a set of traffic classes based on the application type, where each traffic class has a different assigned priority. Each stream can also be assigned a maximum and a minimum bandwidth based on the application type. In some implementations, the router can control the dropping and/or delaying of packets for a stream based on the traffic class and the maximum/minimum bandwidths associated with the stream. Similarly, the router can control the rate at which receipt acknowledgements are sent for a particular stream based on the traffic class and the maximum/minimum bandwidths associated with the stream. In one example, in response to determining a stream is exceeding its assigned maximum bandwidth, the router can temporarily classify the stream in a lower priority traffic class, thereby reducing the bandwidth allocated to the stream. In response to determining a stream is below its assigned minimum bandwidth, the router can change the traffic class of the stream to a higher priority traffic class, or change the traffic class of other communication streams to a lower priority, in order to increase the bandwidth allocated to the stream.

For example, one communication endpoint, such as a computer device, can be streaming a video and a different communication endpoint can be executing a peer-to-peer (P2P) file communication program. Typically, streaming videos are placed in a higher priority traffic class than the traffic class of P2P file communication programs. In particular, for a streaming video application, the application typically needs to be receiving packets at a rate greater than the play rate or the video will freeze. A P2P file communication application, in contrast, typically takes a relatively long amount of time, and rapid communication of a particular packet associated with the P2P file communication program does not significantly affect the user experience. Accordingly, in some implementations, the router described herein may detect the application type associated with each stream; i.e., the router may detect one stream is streaming video and the other stream is a file download. The router can also assign both minimum and maximum bandwidths to each stream based on the detected application type. The router can place the streaming video communication stream in a higher priority traffic class relative to the traffic class of the P2P file communication stream, thereby prioritizing streaming video packets above P2P file communication packets until the streaming video communication stream reaches its assigned maximum bandwidth. In one example, when the steaming video communication stream reaches its assigned maximum bandwidth, the streaming video communication stream can be assigned to a lower traffic class, thereby providing the P2P file download communication stream with additional bandwidth. In this way, no application in the network can monopolize the available bandwidth. In contrast, in a conventional system, the streaming video communication stream would typically be maintained in the high priority traffic class even if it consumes more bandwidth than the associated application could usefully employ (i.e., the maximum bandwidth), thereby harming the performance of the other applications in the network (e.g., the P2P file download) without any compensating benefit.

In some implementations, to manage the bandwidth used by a communication stream associated with a particular traffic class, the router can drop packets for the stream at rate based on the traffic class. Because the receiving endpoint or router will typically request retransmission of dropped packets, by increasing the rate at which packets are dropped, the router effectively slows the rate at which the transmitting endpoint successfully transfers information. This reduces the amount of bandwidth used by the communication stream. This in turn increases the amount of bandwidth available to communication streams associated with a higher traffic class.

In some implementations, based on the traffic class, the router can also set the timing at which acknowledgment packets are sent in order to manage bandwidth. In particular, for some communication protocols, a transmitting endpoint will wait to send packets until an acknowledgement has been received to indicate that previously sent packets have been received. Accordingly, by delaying sending an acknowledgement in response to a received packet, the router can effectively decrease the rate at which the transmitting endpoint sends packets for a particular communication stream. This will reduce the amount of bandwidth used by the communication stream so that it does not exceed a maximum bandwidth threshold.

FIG. 1 is a block diagram of a router 102 that implements the network traffic prioritization and bandwidth management mechanism, according to some embodiments. As shown in FIG. 1, a communication system may include a local area network (LAN) 100 and a wide area network (WAN) 150. The LAN 100 comprises a plurality of network devices 101 and a router 102. The plurality of network devices 101 may include various type of wired and wireless networking devices, such as notebook computers, tablet computers, mobile phones, desktop computers, digital cameras, televisions, gaming consoles, smart appliances, and other suitable network devices. The router 102 (or gateway) may be a network traffic managing node between two or more networks that receives, processes, and routes packets associated with the networks. It is noted, however, that in other embodiments the LAN 100 may include other types of network traffic managing nodes that are configured to perform various functions for the network(s), e.g., a server computer system that incorporates one or more of a cable modem, gateway/router, wireless access point, bridge, switch and/or storage, which may also implements the functionality describe herein with reference to FIGS. 1-7. As shown in FIG. 1, the router 102 allows the network devices 101 of the LAN 100 to access the WAN 150 and receive content from the WAN 150 of the communication network. For example, the LAN 100 may receive content from a network of servers 158 of a service provider. The LAN 100 may be one of many LANs that form the communication network, which may be generally referred to as the Internet 155. The communication network includes a number of nodes, whereby a network node is a node in the network that can provide and/or receive packets. Accordingly, nodes can be generally classified as endpoints or routing nodes with respect to a particular communication session. An endpoint refers to either an originating source or end destination of payload information included in a packet. A routing node refers to a node that receives packets from one or more network nodes and provides the packets, based on destination information included with each packet, to one or more other network nodes. It will be appreciated that a network node can be a routing node with respect to one packet and an endpoint with respect to another packet. Thus, for example, a server device can originate information for communication to an endpoint, and can also route received packets to other network nodes. The server is therefore an endpoint with respect to the packet that it originated, and a routing node with respect to the packets that it receives from the network for routing to other nodes.

In some embodiment, router 102 is incorporated at a routing node of a communication network, and includes a number of modules to facilitate receiving and routing of packets to other network nodes. For example, the router 102 can be incorporated in the LAN 100 to facilitate communications between the LAN 100 and the WAN 150 of the communication network. In another example, the router 102 may be incorporated in a routing node of the Internet 155 (e.g., in the network of the Internet service provider) or in a routing node of the network of servers 158 of the communication network. In some implementations, as illustrated in FIG. 1, the router 102 includes a router control module 104, a packet buffer 106, a switching fabric 110, and network connections 115-117. Each of the network connections 115-117 may be an input/output connection to the network that allows for both receiving packets from and communicating packets to nodes on the network. For example, each of the network connections 115-117 may be coupled to a different subset of the nodes included in the network. By receiving a packet at one network connection and transmitting the packet via another network connection, the router 102 can communicate the packet from one subset of nodes to another.

In some implementations, the switching fabric 110 may be a communication backbone that routes packets between modules of the router 102. The switching fabric 110 may receive control signaling that indicates which module of the network is to receive a provided packet. Accordingly, the switching fabric 110 may facilitate reception, storage, and provision of packets by the router 102.

In some implementations, the packet buffer 106 may be a memory structure, such as a random access memory (RAM), non-volatile memory, or other memory that stores received packets. The packet buffer 106 can store the packets in individually addressable locations, whereby the packet buffer 106 stores or retrieves packets at the addressable locations based on received control signaling. The control signaling may indicate whether an access request to the packet buffer 106 is a read or write access, and may indicate the address of the location associated with the access. In response, the packet buffer 106 may store a received packet at the indicated location, in the case of a write access, or retrieves a packet stored at the indicated location, in the case of a read access.

In some implementations, the router control module 104 is a module operable to control the operations of the router 102. Accordingly, the router control module 104 can be a general purpose or application specific processor, one or more logic modules to implement a state machine, and the like, or any combination thereof. To control the operations of the router 102, the router control module 104 monitors packets received at the router 102, and provides control signaling to facilitate storage and routing of the received packets based on address information associated with each packet. Furthermore, the router control module 104 can determine an application type associated each communication stream, assign a traffic class to each communication stream based on the application type, and also assign a maximum and minimum bandwidth to the communication stream based on the traffic class, as will be further described below. In one implementation, the router control module 104 can access a routing policy 103, which may include a table or other data structure that stores the defined traffic classes, the priority levels for each traffic class, and minimum and maximum bandwidths associated with each traffic class.

To illustrate, in some implementations, a packet is received at one of the network connections 115-117. Each received packet is associated with an application. As used herein, in one example, an application is associated with a packet if the packet includes payload information provided by the application or is targeted to the application. In response to receiving the packet, the router control module 104 may provide control signaling to the switching fabric 110 to have the packet provided to the packet buffer 106. The router control module 104 may also provide control signaling to the packet buffer 106 so that the received packet is stored at a memory location associated with an address indicated by the router control module 104. The router control module 104 can also provide control signaling to retrieve a packet from the packet buffer 106, analyze the destination address information included in the packet, and control the switching fabric 110 so that the packet is provided to the one of the network connections 115-117 indicated by the destination address. In particular, the router control module 104 can access one or more routing tables (not shown) that indicate destination address ranges associated with each subset of network nodes coupled to the router 102. Based on the subset of nodes indicated by the destination address information, the router control module can control the switching fabric 110 to provide the packet to one of the network connections 115-117 associated with the indicated subset of nodes.

In some implementations, the router control module 104 can manage communication of received packets by, for example, dropping packets and acknowledging received packets. To drop a received packet the router control module 104 does not route the received packet to its destination. For example, the router control module 104 can decline to store a received packet at the packet buffer 106, or can delete the packet from the buffer after it is stored but before it is routed to its destination via one of the network connections 115-117. The router control module 104 can also, in response to receiving a packet, automatically send an acknowledgement to the source of the packet (such as the endpoint that generated the packet) indicating that the packet was received at the router 102. The time between receiving the packet and the router 102 communicating an acknowledgement is referred to as the acknowledgment delay. In some implementations, the router control module 104 can drop packets and adjust the acknowledgment delay in order to manage how many packets associated with a selected communication stream are received within a particular amount of time, thereby limiting the amount of bandwidth consumed by the communication stream.

To illustrate, in some implementations, the router control module 104 can determine a traffic class associated with each communication stream based on the type of application associated with the communication stream and the type of information being communicated by the communication stream. In one example, there are three available traffic classes in descending order of priority: high traffic class, best efforts class, and background class. The router control module 104 can also determine a minimum and maximum bandwidth associated with each application type. In an embodiment, each application type is assigned to a traffic class, and the minimum and maximum bandwidths are assigned based on the traffic class. In another embodiment, different communication streams in the same traffic class can be assigned different minimum and maximum bandwidths (e.g., based on the specific application). In some implementations, the high traffic class may be subdivided into two different classes; for example, real-time traffic class and streaming traffic class. The real-time traffic class may include application types with real-time data traffic, such as gaming applications, VoIP applications (e.g., Vonage®), and video chat applications (e.g., Skype®), and the streaming traffic class may include application types with streaming data traffic, such as streaming video applications (e.g., Netflix® and YouTube®) and streaming music applications (e.g., Pandora®). In other implementations, the router control module 104 can determine a priority and a minimum/maximum bandwidth to assign to each communication stream based on the actual application (e.g., Netflix application) instead of (or in addition to) the application type (e.g., streaming video application). For example, in some cases, two different streaming video applications (e.g., Netflix and YouTube) may be assigned different minimum/maximum bandwidths (and potentially different priorities) because one specific application may be more latency insensitive, or because one specific application may be regarded as more important by user configurations at the router.

In some embodiments, the router 102 stores the routing policy 103 which includes a table or other data structure that indicates the traffic classes, priority levels for each traffic class, minimum and maximum bandwidths associated each traffic class, and the traffic classes associated with a set of applications executing at one or more endpoints that communicates (transmits or receives) packets via the router 102. The router control module 104 is configured to access the routing policy 103 in order to manage communication of packets according to the traffic class associated with each communication stream, as described above. In some implementations, the table or other data structure of the routing policy 103 may indicate the traffic class, priority levels, minimum and maximum bandwidths based on the actual application.

Accordingly, in some implementations, upon receiving a packet at the router 102, the router control module 104 can determine the communication stream associated with the packet by determining 1) the application that is associated with the packet; and 2) the type of information being communicated by the packet. In some examples, the router control module 104 can determine the application associated with the packet and the type of information being communicated by the packet based on the router port number that received the packet, header information included in the packet, such as an application name, port number, address, or other information, or any combination thereof. In one embodiment, the router control module 104 can determine the communication stream associated with the packet, either in whole or in part, by inspecting a data payload of the packet or based on a combination of information in the header and information in the data payload. In another embodiment, the router control module 104 can determine the communication stream associated with received packets based on characteristics of the packets and their communication, such as the size of the packets, the frequency with which the packets are communicated to the router 102, and the like. In other embodiments, the router control module 104 can determine the communication stream associated with received packets based on information received from an external source, such as the application that communicated the packets, a remote server, an external computer device different from the one that communicated the packets, and the like.

Upon determining the communication stream associated with a received packet, the router control module 104 can access the routing policy 103 to determine the traffic class associated with the communication stream (e.g., as indicated by the application associated with the communication stream and the type of information associated with the communication stream). In some implementations, the routing policy 103 indicates a set of application types and a traffic class associated with each type. For example, the routing policy 103 can indicate that a video streaming application is assigned to a relatively high priority traffic class while a P2P file communication application is assigned to a relatively lower priority traffic class. In this embodiment, router control module 104 can receive information, such as from a communication endpoint, indicating the type of application associated with each received packet, and determine the traffic class for a communication stream according to the application type associated with the stream. The routing policy 103 can be updated over time to reflect the traffic class associated with each application or application type as the traffic class associated with an application or application type changes. In one embodiment, a single application can be associated with multiple communication streams, and that each of these communication streams can be assigned to a different traffic class. Thus, for example, a web browser application could simultaneously or concurrently control both 1) a streaming video communication stream and 2) a file download communication stream. The streaming video communication stream can be assigned to a traffic class having a higher priority than the traffic class to which the file download stream is assigned.

In some implementations, the router control module 104 can also access the routing policy 103 to determine the minimum and maximum bandwidth associated with the traffic class of each communication stream. The router control module 104 can manage the traffic class for each communication stream based on whether the stream is reaching the minimum bandwidth, or exceeding the maximum bandwidth, of its originally assigned traffic class as indicated by the routing policy 103. As described above, in some implementations, the router control module 104 can access the routing policy 103 to determine the minimum and maximum bandwidths associated with the actual application that is associated with the communication stream. The router control module 104 can manage the communication streams based on the minimum/maximum bandwidths (e.g., determine whether the bandwidth is reaching the minimum/maximum bandwidths associated with the application), as will be further described below.

The minimum and maximum bandwidth can each be expressed according to a number of packets received within a designated unit of time, such as X number of packets per second. In some implementations, the router control module 104 can monitor, over time, the number of packets received for a communication stream and determine whether the communication stream is reaching its assigned minimum bandwidth. If not, the router control module 104 can reduce the bandwidth consumed by communication streams associated with lower priority traffic classes. In one example, the router control module 104 can reduce the bandwidth by deliberately dropping packets associated with the lower priority communication streams. In another example, the router control module 104 can reduce the bandwidth by increasing the time between receiving a packet for the lower priority communication stream and sending an acknowledgement that the packet has been received. In still another example, the router control module 104 may reduce the bandwidth both by dropping packets and by increasing the acknowledgement delay.

The router control module 104 can also determine that a communication stream is exceeding its assigned maximum bandwidth. In response, the router control module 104 can temporarily assign the communication stream to a lower priority traffic class. The router control module 104 can also change the traffic class of other communication streams to higher priority traffic classes. The traffic classes of each communication stream are thereby reordered such that communication streams exceeding their maximum bandwidth (referred to as exceeding streams) are lowered in priority. Because of the change in priority, the bandwidth of the exceeding streams will be reduced (by, for example, dropping packets or delaying acknowledgements for the streams). After the bandwidth associated with the exceeding streams is reduced, the newly available bandwidth may be used for other communication streams in the network; for example, the available bandwidth can be used if another communication stream drops below its minimum bandwidth.

This can be better understood with reference to an example, where a first stream, designated Stream 1, is assigned to the high priority traffic class, a second stream, designated Stream 2, is assigned to the best efforts traffic class, and a third stream, designated Stream 3, is assigned to the background traffic class. In response to determining that Stream 1 is not using its assigned minimum bandwidth, the router control module 104 will reduce the bandwidth of Stream 3 by dropping packets or delaying acknowledgments for Stream 3. In the event that the reduction in bandwidth for Stream 3 does not result in Stream 1 achieving its minimum bandwidth, the router control module 104 can also reduce the bandwidth for Stream 2 (i.e., since Stream 2 also has a lower priority compared to Stream 1).

In another example, in response to determining that Stream 1 is exceeding its maximum bandwidth, the router control module 104 may temporarily reassign Stream 1 to the background traffic class, so that Stream 1 is now lower priority than Stream 2. Accordingly, if Stream 2 drops below its assigned minimum bandwidth, the router control module 104 will reduce the bandwidth associated with Stream 1, thereby increasing the bandwidth for Stream 2. The router control module 104 can return Stream 1 to the high priority traffic class after a defined amount of time and/or in response to determining that the bandwidth used by Stream 1 is below its assigned maximum. Thus, the priority associated with a communication stream can be temporarily changed so that the stream does not exceed its maximum for an extended period of time. In contrast, in a conventional system, Stream 1 would typically be maintained in the high priority traffic class even if it consumed more bandwidth than the associated application could usefully employ (i.e., the maximum bandwidth), thereby harming the performance of the applications associated with Stream 2 and Stream 3 without any compensating benefit.

In one embodiment, the routing policy 103 can be provided to router 102 via the network or other communication path by a communication endpoint or other control device. Thus, for example, a communication endpoint can provide the routing policy 103 to the router 102 to indicate the traffic class for each communication stream. This can be useful, for example, if the router 102 provides the primary interface to the network for the endpoint. In another embodiment, the routing policy 103 can be provided by a device other than the source or destination endpoint. For example, a server can provide the routing policy 103 to the router 102 to set the traffic classes for multiple communication streams, such as for streams associated with multiple computer devices connected to a common local area network (LAN). In still another embodiment, the routing policy 103 can be preconfigured at the router 102 prior to sale to an end user. In another embodiment, each application can provide the traffic class for each communication stream communicated by the application to the router 102. In still another embodiment, the router 102 can, in response to receiving a packet from or targeted to an application, query the application to provide information indicating the traffic class for each communication stream provided by the application.

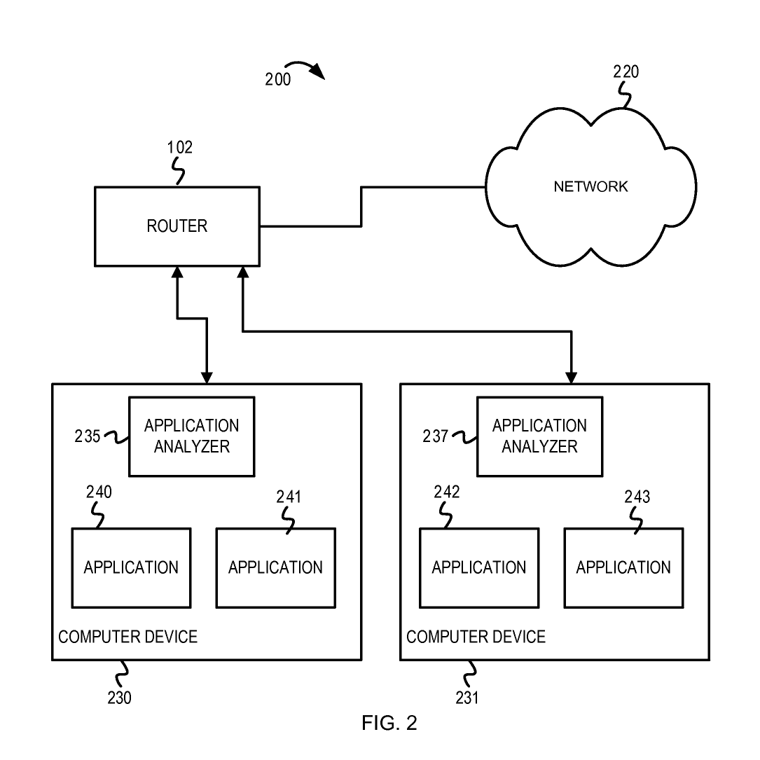

FIG. 2 illustrates a communication system 200 incorporating the router 102 of FIG. 1, according to some embodiments. The communication system 200 also includes network 220 (e.g., the Internet) and computer devices 230 and 231, each connected to the router 202. In the illustrated embodiment, the router 102 routes packets between the computer devices 230 and 231, and between the computer devices 230 and 231 and the network 220. Each of the computer devices 230 and 231 executes applications. For example, computer device 230 executes applications 240 and 241, while computer device 231 executes applications 242 and 243.

In some embodiments, the computer device 230 also executes an application analyzer 235 that is operable to determine the applications that are executing at the computer device 230. For example, the application analyzer 235 can determine the executing applications by accessing process information, task information, or other information provided by an operating system executing at the computer device 230. The application analyzer 235 can also determine the applications that are executing based on what software libraries, device drivers, operating system resources, or other routines, programs, and resources, that are being accessed by each application. Thus, for example, if the application analyzer 235 determines that a video device driver is being accessed at a particular rate, the application analyzer 235 can determine that a video streaming application is being executed. In one implementation, based on the applications being executed, the application analyzer 235 can set or modify the traffic class information stored at the routing policy 103 of the router 102 (shown in FIG. 1), thereby setting or modifying the traffic classes associated with communication streams communicated to the network 220, the computer device 230, or the computer device 231.

In one implementation, the application analyzer 235 can set or modify the routing policy 103 of the router 102 to set different traffic classes for communication streams communicated from and to a particular application. Thus, for example, the application analyzer 235 can set a relatively high minimum bandwidth (e.g., associated with a first traffic class) for a communication stream communicated to application 240 and a relatively low minimum bandwidth (e.g., associated with a second traffic class) for a communication stream communicated from the application 240. Further, the application analyzer 235 can, for example, set the traffic classes for the applications 240 and 241 such that communication streams targeted to application 240 have a higher priority traffic class than communication streams targeted to application 241, while communication streams provided by application 240 have a lower priority traffic class than communication streams provided by application 241. The router 202 thus can manage the upstream (communication streams provided by the applications 240 and 241) and downstream (communication streams provided to the applications 240 and 241) communication of packets individually based on different traffic classes for upstream and downstream communication streams.

In some embodiments, the computer device 231 executes application analyzer 237 which performs similar functions as application analyzer 235. In one implementation, an application analyzer executing at one computer device (e.g., computer device 230) can set the traffic classes for applications executing at a different computer device (e.g., computer device 231, or vice versa). The application analyzer can provide authentication information, such as a password or security code, to the router 102 which authenticates the analyzer based on the authentication information. Based on the authentication, the router 102 can permit or deny the application analyzer from setting the traffic classes for applications executing at a different computer device.

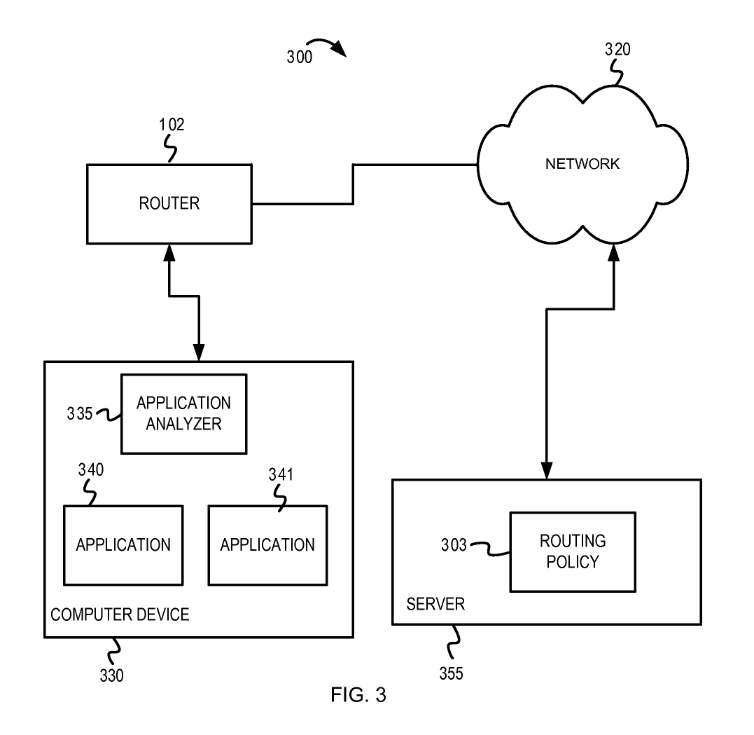

FIG. 3 illustrates a communication system 300 incorporating the router 102 of FIG. 1, according to some embodiments. The communication system 300 also includes network 320 (e.g., the Internet), computer device 330 connected to the router 102, and a server 355. In the illustrated embodiment, the router 102 routes packets between the computer devices 330 and the network 320. The computer device 330 includes an application analyzer 335, and executes applications 340 and 341. The application analyzer 335 may perform similar functions as the application analyzer 235 of FIG. 2. The server 355 stores a routing policy 303.

The communication system 300 may be configured similarly to communication system 200 of FIG. 2. Accordingly, router 102 manages routing of packets to and from the applications 340 and 341 based on the traffic class associated with each communication stream as indicated by the routing policy 303. In the illustrated embodiment, the routing policy 303 is stored at the server 355. Accordingly, when the router 102 receives packets from or targeted to an application via a communication stream having an unknown traffic class, router 102 can query the server 355 to provide the minimum and/or maximum bandwidths for the application as indicated by the routing policy 303. By storing the routing policy 303 at the server 355, the policy can be more easily updated and modified. Further, the routing policy 303 can be used to provide traffic class information to multiple other routers configured similarly to router 102.

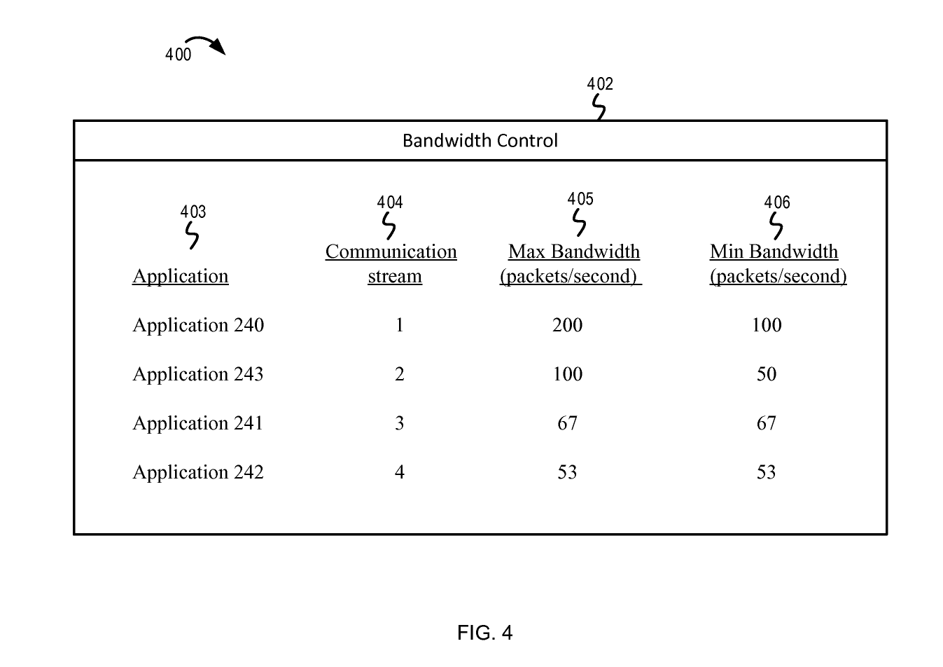

FIG. 4 illustrates a graphical user interface (GUI) 400, according to some embodiments. GUI 400 allows for display and modification of the routing policy 103 of the router 102 (as shown in FIG. 1) via the illustrated bandwidth control window 402. The bandwidth control window 402 displays a column 403, indicating an application identifier (e.g., applications 240, 241, 242, and 243), a communication stream column 404, indicating a communication stream of the associated application (e.g., streams 1, 2, 3, and 4), a maximum bandwidth column 405, indicating the maximum number of packets per second assigned to the communication stream (e.g., 200, 100, 67, and 53 packets/second), and a minimum bandwidth column 406, indicating the minimum number of packets assigned to the communication stream (e.g., 100, 50, 67, and 53 packets/second).

The bandwidth control window 402 allows a user to modify the routing policy 103 by setting the minimum and maximum bandwidth for each communication stream. In one embodiment, the text of bandwidth column 405 can be edited by the user to change the maximum bandwidth. For example, the user could enter the number “75” for Application 243. The GUI 400 can automatically reorganize the display of the applications in application column 403 to reflect the adjusted bandwidth. Further, GUI 400 can communicate a change in traffic class to router 102, which can then update the routing policy 103. The minimum bandwidth can be changed in a similar fashion by adjusting the text of column 406. In another embodiment, the bandwidth control window 402 can include a traffic class column (not shown), whereby the traffic class for an application can be modified. In this embodiment, the columns 405 and 406 can be employed to adjust the bandwidth for each traffic class. As described above, it is noted that the routing policy 103 at the router 102 can be modified and updated in various other ways; for example, the routing policy 103 can be modified and updated at a remote server and sent to the router 102 for configuration.

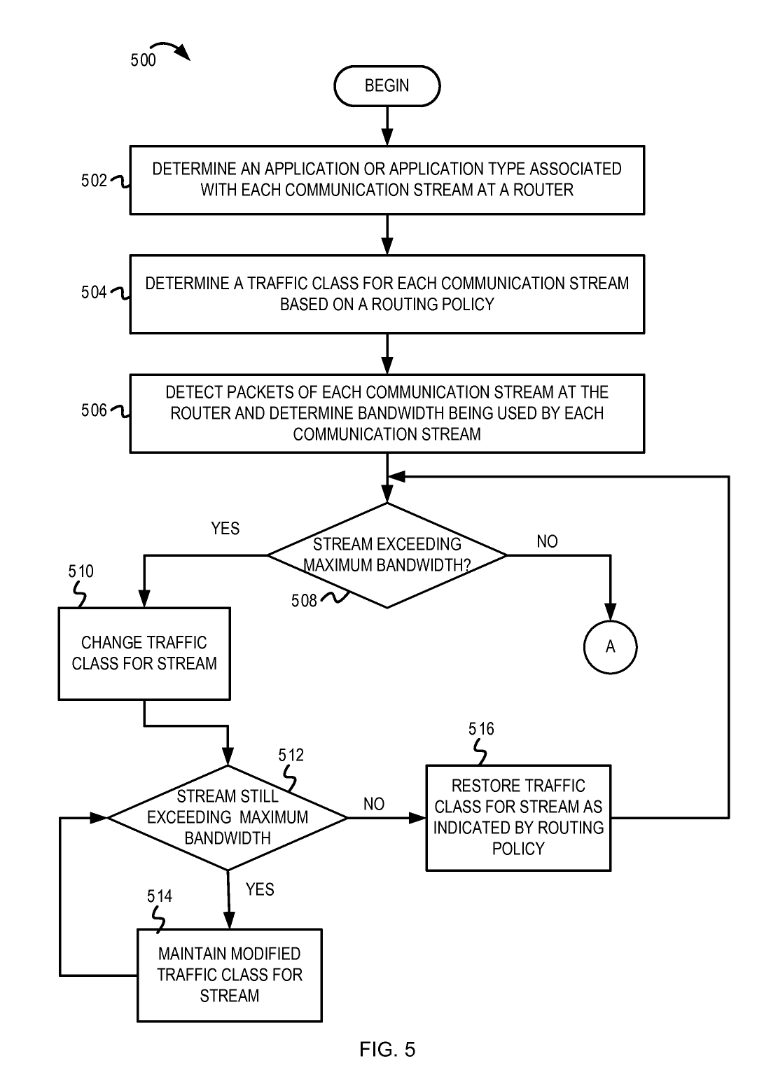

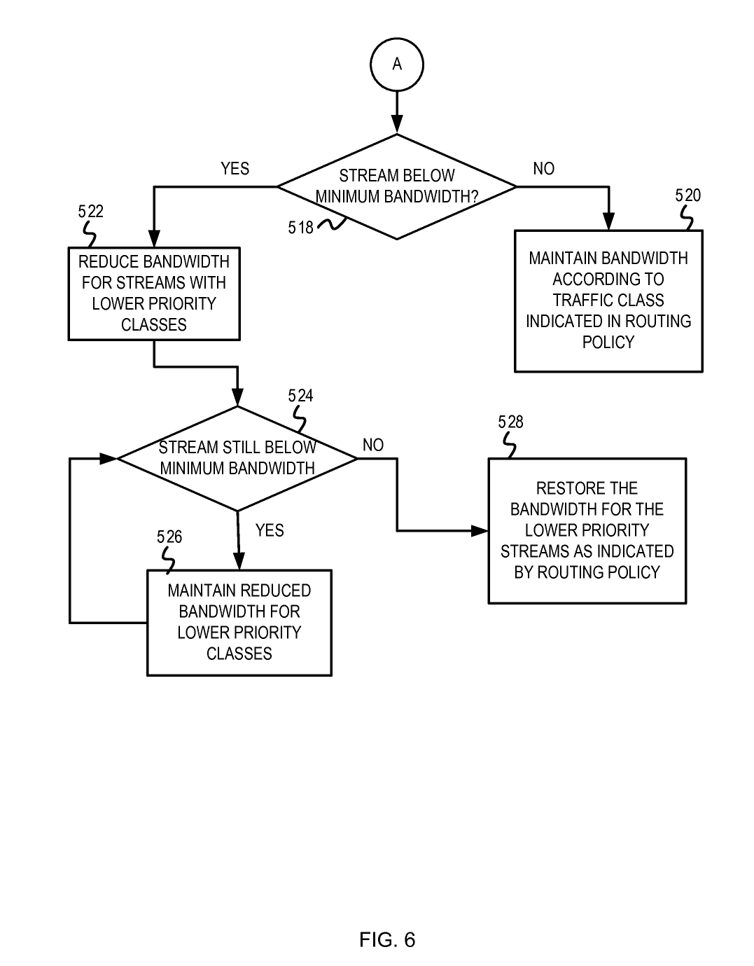

FIG. 5 and FIG. 6 are flow diagrams (“flows”) illustrating operations 500 for managing routing of packets at the router 102 based on a traffic class associated with an application type, according to some embodiments. The flow begins at block 502 of FIG. 5 and continues with block 518 of FIG. 6.

At block 502, the router 102 determines an application or application type associated with each communication stream. In response to detecting the communication streams, the router 102 may determine the applications or application types being executed at remote computer devices that are associated with the communication streams. In one implementation, this determination can be made by the router control module 104 of the router 102 receiving information from each remote computer device or server indicating the applications, or application types, being executed at the corresponding device. In another implementation, this determination can be made by the router control module 104 analyzing one or more received packets, and determining the application or application type based on the analysis. In one example, the router control module 104 may determine the application or application type associated with a packet based on the header and/or the payload information included in the packet. After block 502, the flow continues at block 504.

At block 504, the router 102 accesses the routing policy 103 to determine the traffic class for each communication stream. As described above, the router control module 104 can determine the traffic class for each communication stream based on the application or application type associated with a corresponding communication stream by accessing the routing policy 103. After block 504, the flow continues at block 506.

At block 506, the router 102 detects packets of each communication stream and determines the bandwidth being used by each communication stream. In one example, the router control module 104 receives packets communicated from the applications executing at the remote computer devices and/or receives packets communicated to the applications executing at the remote computer devices. The router control module 104 can also determine the bandwidth being used by each communication stream for comparison to the minimum and maximum bandwidths assigned to each communication stream based on the traffic class. After block 506, the flow continues at block 508.

At block 508, for each communication stream, the router 102 determines whether the bandwidth being used by the communication stream is exceeding the maximum bandwidth associated with the particular communication stream. In one implementation, the router control module 104 determines whether a communication stream is exceeding the maximum bandwidth that is assigned based on the traffic class. If the assigned maximum bandwidth is not exceeded, the flow continues at block 518 of FIG. 6, where it's determined whether the bandwidth is below a minimum bandwidth. If the assigned maximum bandwidth is exceeded, the flow continues at block 512.

At block 510, in response to determining the bandwidth being used by a communication stream has exceeded the maximum bandwidth, the router 102 changes the traffic class assigned for the communication stream. In one implementation, the router control module 104 can change the traffic class for the communication stream to a lower priority class. In one example, changing the traffic class to the lower priority class can automatically reduce the bandwidth allocated to the communication stream. In another example, changing the traffic class to the lower priority class can cause the bandwidth used by the communication stream to be reduced in the event that another communication stream falls below its assigned minimum bandwidth. In other words, if the bandwidth allocated to the communication stream is reduced to be at or below the maximum bandwidth, the newly available bandwidth can be assigned to the other communication stream that is below its assigned minimum bandwidth. After block 510, the flow continues at block 512.

At block 512, the router 102 determines whether the communication stream continues to exceed the assigned maximum bandwidth. If the router control module 104 determines the bandwidth being used by the communication stream continues to exceed the assigned maximum bandwidth, the flow continues to block 514. If the router control module 104 determines the bandwidth being used by the communication stream does not exceed the assigned maximum bandwidth, the flow continues to block 516.

At block 514, the modified traffic class for the communication stream is maintained. For example, the router control module 104 maintains the lower priority traffic class assigned to the communication stream until the bandwidth being used by the communication stream is at or below the maximum bandwidth. After block 512, the flow loops back to block 514 to continue checking whether the communication stream exceeds the assigned maximum bandwidth.

At block 516, the traffic class for the communication stream is restored to the traffic class indicated by the routing policy. In one implementation, after the bandwidth associated with the communication stream is reduced to a level at or below the maximum bandwidth, the router control module 104 restores the traffic class indicated by the routing policy for the communication stream (i.e., a higher priority class). After block 516, the flow loops back to block 508 to continue monitoring the bandwidth of each communication stream.

As described above, to reduce the bandwidth, the router control module 104 may drop a determined number of packets, either by not storing the packets at the packet buffer 106, or by deleting the number of packets for the communication stream already stored at the packet buffer 106. The router control module 104 may store and route any packets that are not dropped for the communication stream.

At block 518 of FIG. 6, for each communication stream, the router 102 determines whether the bandwidth being used by the communication stream is below the minimum bandwidth associated with the corresponding communication stream. In one implementation, the router control module 104 determines whether a communication stream is consuming a bandwidth that is below the minimum bandwidth that is assigned based on the traffic class (as indicated by the routing policy 103). If the bandwidth is above the assigned minimum bandwidth, the flow continues at block 520. If the bandwidth is below the assigned minimum bandwidth, the flow continues at block 522.

At block 520, in response to determining the bandwidth being used by a communication stream is above the minimum bandwidth, and also is below the maximum bandwidth, the router 102 maintains the bandwidth according to the assigned traffic class for the communication stream indicated by the routing policy 103. In one implementation, the router control module 104 maintains the assigned traffic class and stores and routes all the received packets for the communication stream according to the traffic class. The router control module 104 may then continue monitoring the bandwidth of the communication streams based on the assigned minimum and maximum bandwidths.

At block 522, the bandwidth is reduced for communication streams with lower priority classes. In some implementations, the router control module 104 can determine which communication streams have a lower priority class compared to the communication stream that is below the minimum bandwidth, and reduce the bandwidth for the communication streams with the lower priority class. In one example, the communication stream may not be able to use its assigned minimum bandwidth because other communication streams may be using too much bandwidth. As described above, in one example, the bandwidth of the other streams can be reduced by dropping packets, increasing the acknowledgement delay, or a combination thereof. By reducing the bandwidth of the communication streams with the lower priority class, the router control module 104 can allocate the newly available bandwidth to the communication stream having a bandwidth below the minimum bandwidth, in order to increase the bandwidth above the minimum bandwidth. After block 522, the flow continues at block 524.

At block 524, the router determines whether the bandwidth of the communication stream is still below the minimum bandwidth. If the bandwidth is still below the minimum bandwidth, the flow continues at block 526. If the bandwidth is no longer below the minimum bandwidth, the flow continues at block 528.

At block 526, the reduced bandwidth for the communication streams associated with lower priority classes is maintained. For example, the router control module 104 maintains the reduced bandwidth until the bandwidth being used by the communication stream is at or above the minimum bandwidth. After block 526, the flow loops back to block 524 to continue checking whether the bandwidth of the communication stream is below the assigned minimum bandwidth.

At block 528, the bandwidth for the communication streams associated with the lower priority class is restored to the bandwidth indicated by the routing policy. In one implementation, after the bandwidth associated with the communication stream is increased to a level at or above the minimum bandwidth, the router control module 104 restores the bandwidth for the lower priority classes as indicated by the routing policy. The router control module 104 may then continue monitoring the bandwidth of the communication streams based on the assigned minimum and maximum bandwidths.

It should be understood that FIGS. 1-6 and the operations described herein are examples meant to aid in understanding embodiments and should not be used to limit embodiments or limit scope of the claims. Embodiments may perform additional operations, fewer operations, operations in a different order, operations in parallel, and some operations differently.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

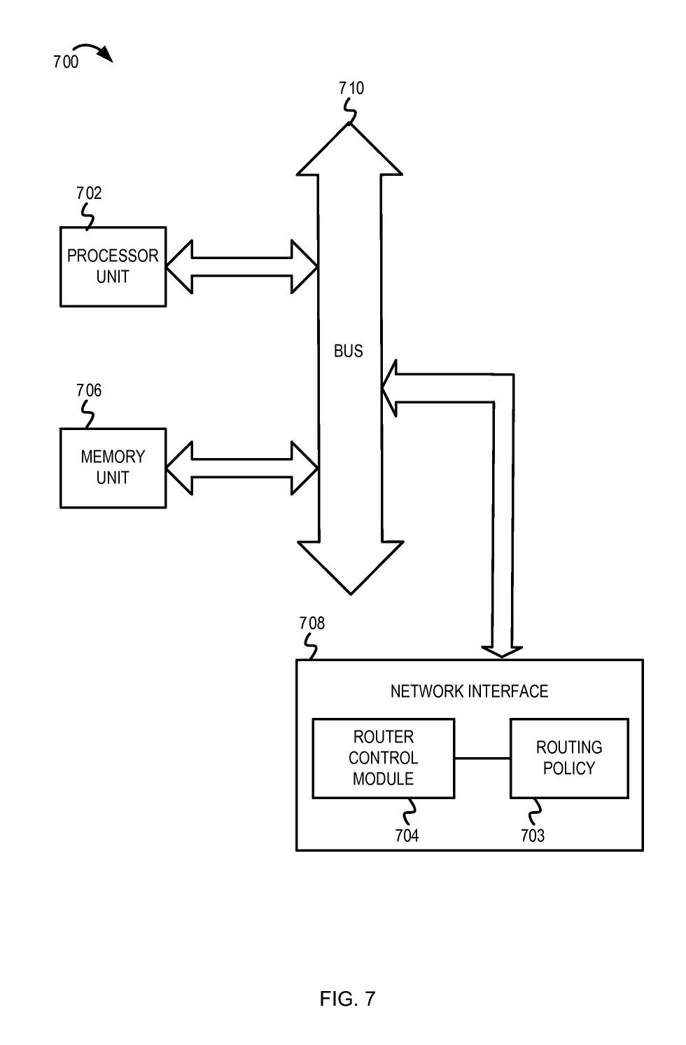

FIG. 7 is a block diagram of one embodiment of a network device 700 including a mechanism for managing routing of packets based on a traffic class associated with an application type, according to some embodiments. In some implementations, the network device 700 is a network traffic managing node between two or more networks (e.g., a LAN and a WAN) that receives, processes, and routes packets associated with the networks; for example, the network traffic managing node may be a router/gateway of a LAN (e.g., LAN 100 shown in FIG. 1). It is noted, however, that in other implementations the network device 700 may be other suitable types of network devices that can be configured to implement the functionality described above with reference to FIGS. 1-6, such as a cable modem, a wireless access point, a network bridge, a network switch, a desktop computer, a gaming console, a mobile computing device, etc. The network device 700 includes a processor unit 702 (possibly including multiple processors, multiple cores, multiple nodes, and/or implementing multi-threading, etc.). The network device 700 includes a memory unit 706. The memory unit 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The network device 700 also includes a bus 710 (e.g., PCI, ISA, PCI-Express, HyperTransport®, InfiniBand®, NuBus, AHB, AXI, etc.), and network interface(s) 708 that include at least one of a wireless network interface (e.g., a Bluetooth interface, a WLAN 802.11 interface, a WiMAX interface, a ZigBee® interface, a Wireless USB interface, etc.) and a wired network interface (e.g., an Ethernet interface, a powerline communication interface, etc.). As illustrated, the network interface(s) 708 also includes a router control module 704 and a routing policy 703. Although not shown, the network interface(s) 708 may also include a switch fabric, a packet buffer, and network connections similarly as shown in FIG. 1. In one example, the router control module 704 and the routing policy 703 (and other components) may be implemented within a network interface card or network interface module of the network interface(s) 708. The router control module 704 and the routing policy 703 (and other components) may be operable to implement the routing and bandwidth management mechanism for the network device 700, as describe above with reference to FIGS. 1-6.

Any one of these functionalities may be partially (or entirely) implemented in hardware and/or on the processor unit 702. For example, the functionality may be implemented with one or more application specific integrated circuits, one or more system-on-a-chip (SoC), or other type of integrated circuit(s), in logic implemented in the processor unit 702, in a co-processor on a peripheral device or card, in a separate processor and/or memory implemented within the network interface 708, etc. Further, realizations may include fewer or additional components not illustrated in FIG. 7 (e.g., video cards, audio cards, additional network interfaces, peripheral devices, etc.). The processor unit 702, the memory unit 706, and the network interfaces 708 are coupled to the bus 710. Although illustrated as being coupled to the bus 710, the memory unit 706 may be coupled to the processor unit 702.

While the embodiments are described with reference to various implementations and exploitations, it will be understood that these embodiments are illustrative and that the scope of the inventive subject matter is not limited to them. In general, techniques for implementing a communication stream routing and bandwidth management mechanism as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a first application associated with a first communication stream of a communication network, the first communication stream comprising a first plurality of packets;
assigning a first maximum bandwidth to the first communication stream, the first maximum bandwidth determined based on a first traffic class associated with the first application;
managing routing of the first communication stream based, at least in part, on the first traffic class and the first maximum bandwidth;
assigning a second maximum bandwidth associated with a second traffic class to the first communication stream in response to determining a bandwidth associated with the first communication stream exceeds the first maximum bandwidth associated with the first traffic class; and
managing routing of the first communication stream based, at least in part, on the second traffic class and the second maximum bandwidth.

2. The method of claim 1, further comprising:
assigning both a first minimum bandwidth and the first maximum bandwidth to the first communication stream;
reducing a bandwidth associated with a subset of a plurality of additional communication streams of the communication network in response to determining the bandwidth associated with the first communication stream is less than the first minimum bandwidth associated with the first traffic class; and
allocating additional bandwidth to the first communication stream to increase the bandwidth associated with the first communication stream above the first minimum bandwidth in response to said reducing the bandwidth associated with the subset of the plurality of additional communication streams.

3. The method of claim 1, wherein said determining the first application associated with the first communication stream comprises determining an application type associated with the first communication stream or determining a specific application associated with the first communication stream.

4. The method of claim 1, wherein said managing routing of the first communication stream is performed at a network router of the communication network.

5. The method of claim 1, wherein said managing routing of the first communication stream based on the second traffic class and the second maximum bandwidth comprises, in response to assigning the second traffic class to the first communication stream, reducing a maximum bandwidth associated with the first communication stream from the first maximum bandwidth to the second maximum bandwidth, wherein the second maximum bandwidth is less than the first maximum bandwidth.

6. The method of claim 5, wherein said reducing the maximum bandwidth further comprises reducing the bandwidth associated with the first communication stream by dropping packets of the first communication stream in order to reduce the bandwidth associated with the first communication stream below the first maximum bandwidth.

7. The method of claim 5, wherein said reducing the maximum bandwidth further comprises reducing the bandwidth associated with the first communication stream by increasing a delay associated with sending an acknowledgement that a packet of the first communication stream has been received in order to reduce the bandwidth associated with the first communication stream below the first maximum bandwidth.

8. The method of claim 1, further comprising restoring the first communication stream to the first traffic class in response to determining that the bandwidth associated with the first communication stream is below the first maximum bandwidth associated with the first traffic class.

9. The method of claim 1, wherein said managing routing of the first communication stream based on the second traffic class and the second maximum bandwidth comprises:
determining that the bandwidth associated with the first communication stream is less than the first maximum bandwidth associated with the first traffic class in response to determining the bandwidth associated with the first communication stream is less than the second maximum bandwidth, wherein the second maximum bandwidth is less than the first maximum bandwidth; and
reassigning the first maximum bandwidth associated with the first traffic class to the first communication stream in response to determining that the bandwidth associated with the first communication stream is below the first maximum bandwidth associated with the first traffic class.

10. The method of claim 1, wherein said managing routing of the first communication stream based on the second traffic class and the second maximum bandwidth comprises:
managing routing of the first communication stream based on the second traffic class and the second maximum bandwidth for a predefined amount of time; and
reassigning the first maximum bandwidth associated with the first traffic class to the first communication stream after the predefined amount of time.

11. The method of claim 2, wherein said reducing the bandwidth associated with the subset of the plurality of additional communication streams of the communication network in response to determining the bandwidth associated with the first communication stream is less than the first minimum bandwidth associated with the first traffic class comprises:
reducing the bandwidth of one or more of the additional communication streams that are associated with a traffic class having a lower priority compared to a priority of the first traffic class associated with the first communication stream.

12. The method of claim 1, wherein said determining the first application associated with the first communication stream comprises determining the first application based on at least one of header information and payload information included in one or more packets associated with the first communication stream.

13. The method of claim 1, further comprising:
determining a first type of information associated with the first communication stream; and
determining the first traffic class based on the first type of information.

14. The method of claim 13, further comprising:
determining a second type of information communicated via a second plurality of packets, the second plurality of packets associated with a second communication stream associated with the first application;
determining a third traffic class for the second communication stream based on the first application and the second type of information; and
managing routing of the second plurality of packets based on the third traffic class.

15. A method comprising:
receiving, at a network router, information from an external source indicating a first application is associated with a first communication stream comprising a plurality of packets, the first application executing at a first remote computer device;
determining a first traffic class based on the first application; and
managing routing of the first communication stream at the network router based on the first traffic class and a first minimum bandwidth and a first maximum bandwidth associated with the first traffic class to allocate the first communication stream a bandwidth between the first minimum bandwidth and the first maximum bandwidth.

16. The method of claim 15, further comprising determining the first minimum and the first maximum bandwidths by requesting the first minimum and the first maximum bandwidths from the external source.

17. The method of claim 15, wherein the external source comprises the first application.

18. The method of claim 15, wherein the external source comprises a second remote computer device.

19. The method of claim 15, further comprising:
assigning a second maximum bandwidth associated with a second traffic class to the first communication stream in response to determining a bandwidth associated with the first communication stream exceeds the first maximum bandwidth associated with the first traffic class; and
managing routing of the first communication stream based, at least in part, on the second traffic class and the second maximum bandwidth.

20. The method of claim 15, further comprising:
reducing, at the network router, a bandwidth associated with a subset of a plurality of additional communication streams received in response to determining the bandwidth associated with the first communication stream is less than the first minimum bandwidth associated with the first traffic class; and
allocating additional bandwidth to the first communication stream to increase the bandwidth associated with the first communication stream above the first minimum bandwidth in response to said reducing the bandwidth associated with the subset of the plurality of additional communication streams.

21. A network router comprising:
a network interface configured to receive a first communication stream comprising at least one packet;
a router control module configured to:
determine a first application associated with the first communication stream;
assign a first traffic class to the first communication stream based on the first application;
assign a first maximum bandwidth to the first communication stream based on the first traffic class;
manage routing of the first communication stream based on the first traffic class and the first maximum bandwidth associated with the first communication stream;
assign a second maximum bandwidth associated with a second traffic class to the first communication stream in response to determining a bandwidth associated with the first communication stream exceeds the first maximum bandwidth associated with the first traffic class; and
manage routing of the first communication stream based on the second traffic class and the second maximum bandwidth.

22. The network router of claim 21, wherein the router control module is further configured to:
assign both a first minimum bandwidth and the first maximum bandwidth to the first communication stream;
reduce a bandwidth associated with a subset of a plurality of additional communication streams received at the network router in response to the router control module determining the bandwidth associated with the first communication stream is less than the first minimum bandwidth associated with the first traffic class; and
allocate additional bandwidth to the first communication stream to increase the bandwidth associated with the first communication stream above the first minimum bandwidth in response to said reducing the bandwidth associated with the subset of the plurality of additional communication streams.

23. The network router of claim 21, wherein the router control module configured to determine the first application associated with the first communication stream comprises the router control module configured to determine an application type associated with the first communication stream or determine a specific application associated with the first communication stream.

24. The network router of claim 21, wherein the router control module configured to manage routing of the first communication stream based on the second traffic class and the second maximum bandwidth comprises, in response to the router control module assigning the second traffic class to the first communication stream, the router control module configured to reduce a maximum bandwidth associated with the first communication stream from the first maximum bandwidth to the second maximum bandwidth, wherein the second maximum bandwidth is less than the first maximum bandwidth.

25. The network router of claim 24, wherein the router control module configured to reduce the maximum bandwidth further comprises the router control module configured to reduce the bandwidth associated with the first communication stream by dropping packets of the first communication stream in order to reduce the bandwidth associated with the first communication stream below the first maximum bandwidth.

26. The network router of claim 24, wherein the router control module configured to reduce the maximum bandwidth further comprises the router control module configured to reduce the bandwidth associated with the first communication stream by increasing a delay associated with sending an acknowledgement that a packet of the first communication stream has been received in order to reduce the bandwidth associated with the first communication stream below the first maximum bandwidth.

27. The network router of claim 21, wherein the router control module is further configured to restore the first communication stream to the first traffic class in response to the router control module determining that the bandwidth associated with the first communication stream is below the first maximum bandwidth associated with the first traffic class.

28. The network router of claim 21, wherein the router control module configured to manage routing of the first communication stream based on the second traffic class and the second maximum bandwidth comprises the router control module configured to:
determine that the bandwidth associated with the first communication stream is less than the first maximum bandwidth associated with the first traffic class in response to the router control module configured to determine the bandwidth associated with the first communication stream is less than the second maximum bandwidth, wherein the second maximum bandwidth is less than the first maximum bandwidth; and
reassign the first maximum bandwidth associated with the first traffic class to the first communication stream in response to the router control module configured to determine that the bandwidth associated with the first communication stream is below the first maximum bandwidth associated with the first traffic class.

29. The network router of claim 21, wherein the router control module configured to manage routing of the first communication stream based on the second traffic class and the second maximum bandwidth comprises the router control module configured to:
manage routing of the first communication stream based on the second traffic class and the second maximum bandwidth for a predefined amount of time; and
reassign the first maximum bandwidth associated with the first traffic class to the first communication stream after the predefined amount of time.

30. The network router of claim 22, wherein the router control module configured to reduce the bandwidth associated with the subset of the plurality of additional communication streams in response to the router control module determining the bandwidth associated with the first communication stream is less than the first minimum bandwidth associated with the first traffic class comprises the router control module configured to:
reduce the bandwidth of one or more of the additional communication streams that are associated with a traffic class having a lower priority compared to a priority of the first traffic class associated with the first communication stream.

31. One or more machine-readable storage media having stored therein instructions, which when executed by one or more processors causes the one or more processors to perform operations that comprise:
determining a first application associated with a first communication stream of a communication network, the first communication stream comprising at least one packet;
assigning a first maximum bandwidth to the first communication stream, the first maximum bandwidth determined based on a first traffic class associated with the first application;
managing routing of the first communication stream based, at least in part, on the first traffic class and the first maximum bandwidth;
assigning a second maximum bandwidth associated with a second traffic class to the first communication stream in response to determining a bandwidth associated with the first communication stream exceeds the first maximum bandwidth associated with the first traffic class; and
managing routing of the first communication stream based, at least in part, on the second traffic class and the second maximum bandwidth.

32. The machine-readable storage media of claim 31, wherein the operations further comprise:
assigning both a first minimum bandwidth and the first maximum bandwidth to the first communication stream;
reducing a bandwidth associated with a subset of a plurality of additional communication streams of the communication network in response to determining the bandwidth associated with the first communication stream is less than the first minimum bandwidth associated with the first traffic class; and
allocating additional bandwidth to the first communication stream to increase the bandwidth associated with the first communication stream above the first minimum bandwidth in response to said reducing the bandwidth associated with the subset of the plurality of additional communication streams.

33. The machine-readable storage media of claim 31, wherein said operations of managing routing of the first communication stream based on the second traffic class and the second maximum bandwidth comprise, in response to assigning the second traffic class to the first communication stream, reducing a maximum bandwidth associated with the first communication stream from the first maximum bandwidth to the second maximum bandwidth, wherein the second maximum bandwidth is less than the first maximum bandwidth.

34. The machine-readable storage media of claim 31, wherein said operations further comprise restoring the first communication stream to the first traffic class in response to determining that the bandwidth associated with the first communication stream is below the first maximum bandwidth associated with the first traffic class.

35. The machine-readable storage media of claim 31, wherein said operations of managing routing of the first communication stream based on the second traffic class and the second maximum bandwidth comprise:
determining that the bandwidth associated with the first communication stream is less than the first maximum bandwidth associated with the first traffic class in response to determining the bandwidth associated with the first communication stream is less than the second maximum bandwidth, wherein the second maximum bandwidth is less than the first maximum bandwidth; and
reassigning the first maximum bandwidth associated with the first traffic class to the first communication stream in response to determining that the bandwidth associated with the first communication stream is below the first maximum bandwidth associated with the first traffic class.

36. The machine-readable storage media of claim 31, wherein said operations of managing routing of the first communication stream based on the second traffic class and the second maximum bandwidth comprise:
managing routing of the first communication stream based on the second traffic class and the second maximum bandwidth for a predefined amount of time; and
reassigning the first maximum bandwidth associated with the first traffic class to the first communication stream after the predefined amount of time.

37. The machine-readable storage media of claim 32, wherein said operations of reducing the bandwidth associated with the subset of the plurality of additional communication streams of the communication network in response to determining the bandwidth associated with the first communication stream is less than the first minimum bandwidth associated with the first traffic class comprise:
reducing the bandwidth of one or more of the additional communication streams that are associated with a traffic class having a lower priority compared to a priority of the first traffic class associated with the first communication stream.
